(19) United States
(12) Patent Application Publication
(10) Pub. No.: US 2024/0152835 A1
(43) Pub. Date: May 9, 2024

(54) ORDER QUANTITY CALCULATION APPARATUS AND ORDER QUANTITY CALCULATION SYSTEM

(71) Applicant: Honda Motor Co., Ltd., Tokyo (JP)

(72) Inventors: Kohei Mukaihara, Tokyo (JP); Satoshi Yoshimaru, Tokyo (JP)

(21) Appl. No.: 18/281,465

(22) PCT Filed: Mar. 9, 2022
(86) PCT No.: PCT/JP2022/010249

§ 371 Date: Sep. 11, 2023

(30) Foreign Application Priority Data
Mar. 15, 2021 (JP) 2021-041069

(51) Int. Cl. G06Q 10/0631; G06Q 10/20; G07C 5/00; G07C 5/08

(52) U.S. Cl. CPC G06Q 10/06315; G06Q 10/20; G07C 5/008; G07C 5/0808

(57) ABSTRACT

An order quantity calculation apparatus configured to predict a demand for replacement or repair of predetermined parts used for each of a plurality of vehicles linked with a predetermined area and to calculate an order quantity of the predetermined parts, includes: an average demand quantity calculation unit configured to calculate an average demand quantity of the predetermined parts for a predetermined period based on a result of a past order quantity of the predetermined parts; a vehicle information acquisition unit configured to acquire vehicle information of each of the plurality of vehicles for the predetermined period; an order quantity calculation unit configured to calculate a future order quantity of the predetermined parts in the predetermined area based on the average demand quantity calculated by the average demand quantity calculation unit and the vehicle information acquired by the vehicle information acquisition unit.

### CROSS-REFERENCE TO RELATED APPLICATION

This application is a National Stage of PCT international application Ser. No. PCT/JP2022/010249 filed on Mar. 9, 2022 which designates the United States, incorporated herein by reference, and which is based upon and claims the benefit of priority from Japanese Patent Application No. 2021-041069, filed on Mar. 15, 2021, the entire contents of which are incorporated herein by reference.

### TECHNICAL FIELD

The present invention relates to an order quantity calculation apparatus and an order quantity calculation system that calculate the optimum order quantity of a part.

### BACKGROUND ART

Conventionally, as this type of apparatus, there has been known an apparatus that is configured to calculate the demand prediction value of a future shipment quantity of a maintenance part used for maintenance of a shipped product, and calculate the order quantity based on the demand prediction value (see, for example, Patent Literature 1).

### CITATION LIST

### Patent Literature

Patent Literature 1: Japanese Unexamined Patent Publication No. 2011-232950

### SUMMARY OF INVENTION

### Technical Problem

However, the apparatus described in Patent Literature 1 calculates the demand prediction value of the part by multiplying the past actual shipment quantity of the product by the repair request rate, the part failure rate, and the like, and does not take into account the actual vehicle states of individual vehicles. Therefore, it is difficult to accurately predict the demand of the part by the apparatus.

### Solution to Problem

An aspect of the present invention is an order quantity calculation apparatus configured to predict a demand for replacement or repair of predetermined parts used for each of a plurality of vehicles linked with a predetermined area and to calculate an order quantity of the predetermined parts. The order quantity calculation apparatus includes: an average demand quantity calculation unit configured to calculate an average demand quantity of the predetermined parts for a predetermined period based on a result of a past order quantity of the predetermined parts; a vehicle information acquisition unit configured to acquire vehicle information of each of the plurality of vehicles for the predetermined period; an order quantity calculation unit configured to calculate a future order quantity of the predetermined parts in the predetermined area based on the average demand quantity calculated by the average demand quantity calculation unit and the vehicle information acquired by the vehicle information acquisition unit.

Another aspect of the present invention is an order quantity calculation system, including: an order quantity calculation apparatus; and an in-vehicle apparatus mounted in each of the plurality of vehicles and communicable with the order quantity calculation apparatus.

### Advantageous Effects of the Invention

According to the present invention, it becomes possible to accurately predict a demand of parts to maintain proper stock.

### BRIEF DESCRIPTION OF DRAWINGS

FIG. 1 is a diagram illustrating an example of a configuration of a system including an order quantity calculation apparatus according to an embodiment of the present invention.

FIG. 2 is a block diagram illustrating a configuration of main parts of an in-vehicle apparatus in FIG. 1.

FIG. 3 is a block diagram illustrating a configuration of main parts of the order quantity calculation apparatus 3 according to the present embodiment.

FIG. 4 is a block diagram illustrating a configuration of main parts of a vehicle information acquisition unit in FIG. 3.

FIG. 5A is a diagram illustrating demand predictions of repair parts calculated by the order quantity calculation apparatus according to the present embodiment and demand results.

FIG. 5B is a diagram illustrating demand predictions of repair parts calculated by a conventional order quantity calculation apparatus and demand results.

### DESCRIPTION OF EMBODIMENT

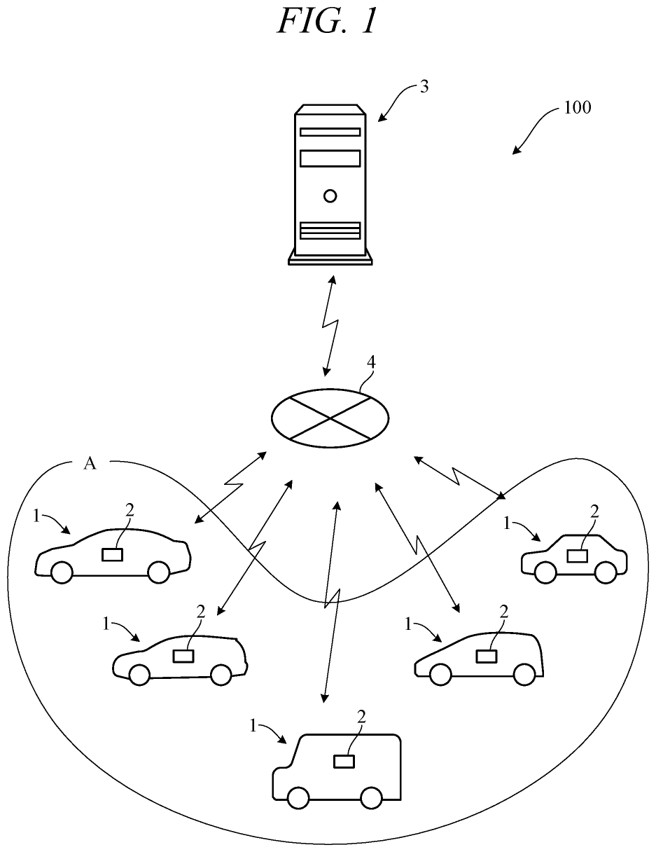

Hereinafter, an embodiment of the present invention will be described with reference to FIGS. 1 to 5B. An order quantity calculation apparatus according to the embodiment of the present invention is an apparatus for predicting a demand for replacement or repair of parts used for each of a plurality of vehicles linked with a predetermined area and calculating the order quantities of the parts. Hereinafter, an example will be described in which an area where the owner of a vehicle lives is set as a predetermined area, the demand for automobile repair parts (hereinafter, referred to as repair parts) in a month after the next month in the predetermined area is predicted, and the order quantity of repair parts (predetermined parts) in the month after the next month in the area is calculated.

FIG. 1 is a diagram illustrating an example of a configuration of a system including an order quantity calculation apparatus according to the embodiment of the present invention (hereinafter, referred to as order quantity calculation system). As illustrated in FIG. 1, the order quantity calculation system 100 includes an in-vehicle apparatus 2 mounted in each of a plurality of vehicles 1 linked with a predetermined area A, and an order quantity calculation apparatus 3 included in a business operator such as an automobile manufacturer that manufactures the vehicles 1.

The in-vehicle apparatus 2 and the order quantity calculation apparatus 3 mounted in each of the plurality of vehicles 1 are communicate with each other via the communication network 4. The communication network 4 includes not only a public wireless communication network represented by the Internet networking, a mobile telephone network, or the like, but also a closed communication network provided for every predetermined management region, for example, a wireless LAN, Wi-Fi (registered trademark), or the like.

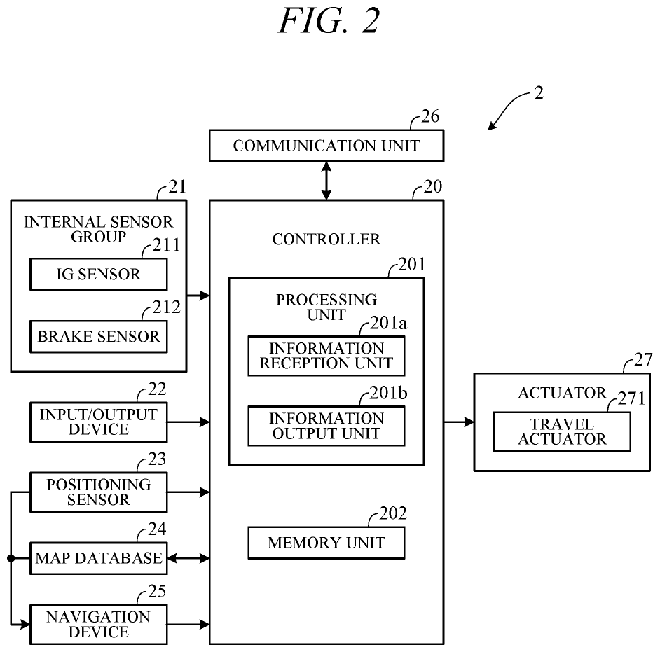

FIG. 2 is a block diagram illustrating a configuration of main parts of the in-vehicle apparatus 2 in FIG. 1. As illustrated in FIG. 2, the in-vehicle apparatus 2 mainly includes a controller 20, an internal sensor group 21 electrically connected to the controller 20, an input/output device 22, a positioning sensor 23, a map database 24, a navigation device 25, a communication unit 26, and an actuator 27.

The internal sensor group 21 is a generic term for a plurality of sensors that detects the traveling state of the vehicle 1 and the state inside the vehicle. For example, the internal sensor group 21 includes an IG sensor 211 that detects an ignition on signal (hereinafter, referred to as IG-ON signal) and an ignition off signal (hereinafter, referred to as IG-OFF signal), a brake sensor 212 that detects operation information of a brake pedal (hereinafter, referred to as brake information), and the like. Although not illustrated, the internal sensor group 21 includes a vehicle speed sensor that detects the vehicle speed of the vehicle 1, an acceleration sensor that detects the acceleration in a front-and-rear direction and the acceleration in a left-and-right direction (lateral acceleration) of the vehicle 1, a sensor that detects the rotation speed or the like of the drive source and tires, a sensor that detects the operation or the like of the accelerator pedal or the steering wheel, and the like. Detection signals from the internal sensor group 21 are transmitted to the controller 20.

The input/output device 22 is a generic term for devices to which commands are input from the driver of the vehicle 1 or from which information is output to the driver. Examples of the input/output device 22 include: various switches via which the driver transmits various commands by operating an operation member; a microphone via which the driver transmits a command in a voice form; a display unit via which the driver receives information in an image form; and a speaker via which the driver receives information in a sound form.

The positioning sensor 23 is, for example, a GPS sensor, receives a positioning signal transmitted from a GPS satellite, and measures an absolute position (latitude, longitude, and the like) of the vehicle 1 based on the received signal. A signal (signal indicating a measurement result) from the positioning sensor 23 is transmitted to the controller 20. The map database 24 is a device, such as a hard disk, that stores typical map information to be used by the navigation device 25. This map information contains road position information, information on a road shape (e.g., curvature) and position information on intersections and branch points.

The navigation device 25 is a device that searches for a target route to a destination on a road which is entered by a driver and guides the driver along the target route. The navigation device 25 provides the entry of the destination and the guidance along the target route via the input/output device 22. The navigation device 25 calculates the target route, based on both a current position of the subject vehicle measured by the positioning sensor 23 and the map information stored in the map database 24.

The communication unit 26 is wirelessly communicable with external apparatuses such as the order quantity calculation apparatus 3 through the communication network 4. The actuator 27 drives various devices mounted in the vehicle 1 in accordance with commands from the controller 20. As an example, the actuator 27 includes a travel actuator 271 for controlling traveling of the vehicle 1. The travel actuator 271 includes a throttle actuator, a brake actuator, a steering actuator, and the like.

The controller 20 includes a computer including a processing unit 201 such as a CPU, a memory unit 202 such as a ROM, a RAM, and a hard disk, and other peripheral circuits (not illustrated). The processing unit 201 functions as an information reception unit 201a and an information output unit 201b by executing a program stored beforehand in the memory unit 202.

The information reception unit 201a receives various signals (various commands), various kinds of information, and the like transmitted from each unit of the in-vehicle apparatus 2 and an external apparatus such as the order quantity calculation apparatus 3. For example, the information reception unit 201a receives an IG-ON signal and an IG-OFF signal detected by the IG sensor 211, brake information detected by the brake sensor 212, and the like.

The information output unit 201b outputs various signals and various kinds of information received by the information reception unit 201a to an external apparatus such as the order quantity calculation apparatus 3 via the communication unit 26. For example, the information output unit 201b outputs the IG-ON signal, the IG-OFF signal, the brake information, and the like received by the information reception unit 201a to the order quantity calculation apparatus 3 together with the ID information of the vehicle 1 via the communication unit 26.

The order quantity calculation apparatus 3 is a terminal managed by an employee of a business operator such as an automobile manufacturer that manufactures the vehicle 1, and includes a server apparatus, for example. The order quantity calculation apparatus 3 can be configured using a virtual server function on a cloud, or may be distributed among a plurality of terminals.

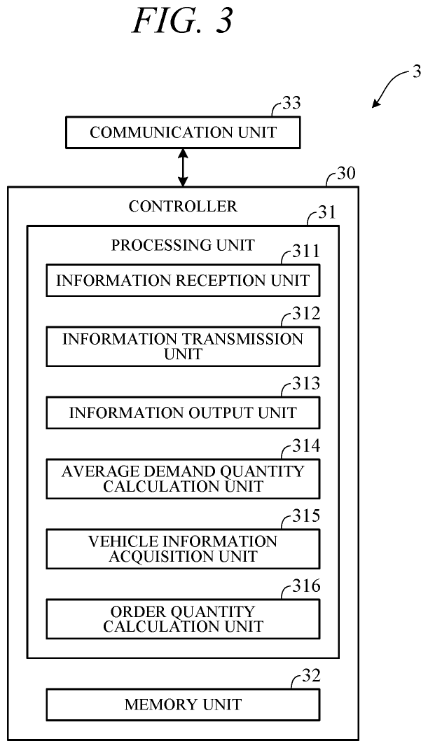

FIG. 3 is a block diagram illustrating a configuration of main parts of the order quantity calculation apparatus 3 according to the embodiment of the present invention. As illustrated in FIG. 3, the order quantity calculation apparatus 3 includes a controller 30 and a communication unit 33 electrically connected to the controller 30. The communication unit 33 is wirelessly communicable with an external apparatus such as the in-vehicle apparatus 2 or with an employee terminal operated by an employee via the communication network 4.

The controller 30 includes a computer including a processing unit 31 such as a CPU, a memory unit 32 such as a ROM, a RAM, and a hard disk, and other peripheral circuits (not illustrated). The processing unit 31 functions as an information reception unit 311, an information transmission unit 312, an information output unit 313, an average demand quantity calculation unit 314, a vehicle information acquisition unit 315, and an order quantity calculation unit 316 by executing an order quantity calculation program stored in advance in the memory unit 32.

The information reception unit 311 receives various kinds of information and various signals transmitted from an external apparatus such as the in-vehicle apparatus 2 or each unit. For example, the information reception unit 311 receives the IG-ON signal, the IG-OFF signal, and the brake information of the vehicle 1 transmitted from the in-vehicle apparatus 2 via the communication unit 33 together with the ID information of the vehicle 1. The information reception unit 311 also receives information on the average demand quantity calculated by the average demand quantity calculation unit 314, the vehicle information acquired by the vehicle information acquisition unit 315, the order quantity information calculated by the order quantity calculation unit 316, and the like.

The information transmission unit 312 transmits various kinds of information and various signals received by the information reception unit 311. For example, the information transmission unit 312 transmits the IG-ON signal, the IG-OFF signal, the brake information, and the like of the vehicle 1 received by the information reception unit 311 together with the ID information of the vehicle 1 to the vehicle information acquisition unit 315. The information transmission unit 312 also transmits the information of the average demand quantity, the vehicle information, and the like received by the information reception unit 311 to the order quantity calculation unit 316.

The information output unit 313 outputs various kinds of information and various signals received by the information reception unit 311 via the communication unit 33. For example, the information output unit 313 transmits the order quantity information received by the information reception unit 311 via the communication unit 33 to an input/output device (monitor) or the like electrically connected to the employee terminal or the order quantity calculation apparatus 3.

The average demand quantity calculation unit 314 calculates the average demand quantity of the repair parts for one month, based on the past record of the order quantity of the repair parts. For example, the average demand quantity calculation unit 314 calculates the average value of the order quantity of the repair parts per month from the results of the order quantities in the most recent six months, and multiplies the average value by a trend coefficient and a season coefficient to calculate the average demand quantity.

The trend coefficient is a coefficient set based on transition of demand for repair parts in the market. The trend coefficient is set to 1 or more when the demand for repair parts is on an increasing trend, and is set to less than 1 when the demand for repair parts is on a decreasing trend. For example, the trend coefficient is set higher as the number of vehicles having the same repair parts on the market is larger, and the trend coefficient is set lower as the number of vehicles having the same repair parts on the market is smaller.

The season coefficient is a coefficient set based on the transition of demand for repair parts in the market for each season (for example, each of four seasons). The season coefficient is set higher in a season with a larger demand for repair parts, and is set lower in a season with a smaller demand. For example, if the number of traffic accidents tends to be large in summer in a predetermined area A, the season coefficient of the repair parts such as the bumper is set to be high, and conversely, if the number of traffic accidents tends to be small in winter in the predetermined area A, the season coefficient of the repair parts such as the bumper is set to be low.

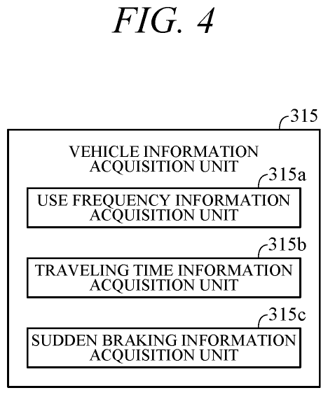

The vehicle information acquisition unit 315 acquires vehicle information for one month of each of the plurality of vehicles 1. FIG. 4 is a block diagram illustrating a configuration of main parts of the vehicle information acquisition unit 315 in FIG. 3. As illustrated in FIG. 4, the vehicle information acquisition unit 315 includes a use frequency information acquisition unit 315a, a traveling time information acquisition unit 315b, and a sudden braking information acquisition unit 315c.

The use frequency information acquisition unit 315a acquires information on a difference in use frequency between the target month (first predetermined period) and the previous month of the target month (second predetermined period) of the plurality of vehicles 1. For example, if the current month is the target month, the use frequency information acquisition unit 315a compares the number of vehicles 1 used a predetermined number of times or more in the previous month with the number of vehicles 1 used a predetermined number of times or more in the current month, and acquires an increase/decrease rate (%) of the number of used vehicles from the previous month to the current month. Specifically, the use frequency information acquisition unit 315a acquires information on an increase/decrease rate (%) of the number of used vehicles 1 from the previous month to the current month, from information on the number of vehicles 1 used five or more times in one month in each of the current month and the previous month. The number of uses of each vehicle 1 is counted based on the number of iterations of receipt of the IG-ON signal associated with the ID information of the vehicle 1.

For example, if the number of vehicles 1 used five times or more in the previous month is 100 and the number of vehicles 1 used in the current month is 120, the rate of increase/decrease in the number of used vehicles 1 in the predetermined area A from the previous month to the current month is 20%. On the other hand, if the number of vehicles 1 used five times or more in the previous month is 100 and the number of vehicles 1 used in the current month is 90, the rate of increase/decrease in the number of used vehicles 1 in the predetermined area A from the previous month to the current month is −10%.

In the present embodiment, the information on the number of vehicles 1 used five or more times in one month is acquired. However, the condition for the number of uses of each vehicle 1 in one month acquired by the use frequency information acquisition unit 315a can be arbitrarily set.

If the order quantity calculation apparatus 3 calculates the order quantity in the month after next, the use frequency information acquisition unit 315a acquires an increase/decrease rate (%) of the number of vehicles 1 used in the current month, the next month, and the month after next as the target months. The increase/decrease rate (%) of the number of vehicles used in the current month is acquired as described above. The increase/decrease rate (%) of the number of vehicles used in the next month is acquired using the number of vehicles used in the current month and the predicted number of vehicles used in the next month. As the predicted number of vehicles used in the next month, for example, an approximate line is created from past results of the number of vehicles used, and the predicted number of vehicles used in the next month obtained from the created approximate line can be used. Similarly, the increase/decrease rate (%) of the predicted number of vehicles used in the month after next is acquired using the predicted number of vehicles used in the next month and the predicted number of vehicles used in the month after next which are obtained from an approximate line created from the past record of the number of vehicles used.

The traveling time information acquisition unit 315b acquires information on a difference in traveling time between the target month (first predetermined period) and the previous month of the target month (second predetermined period) of the plurality of vehicles 1. For example, if the current month is the target month, the traveling time information acquisition unit 315b compares the traveling times of the plurality of vehicles 1 in the previous month with the traveling times of the plurality of vehicles 1 in the current month, and acquires an increase/decrease rate (%) of the traveling times of the plurality of vehicles 1 from the previous month to the current month. Specifically, the traveling time information acquisition unit 315b sets, as the traveling time of each vehicle 1, a time slot from detection of the IG-ON signal to detection of the IG-OFF signal associated with the ID information of the vehicle 1, and acquires an increase/decrease rate (%) of the traveling times from this information on the plurality of vehicles 1.

For example, if the total traveling time of the plurality of vehicles 1 associated with the predetermined area A in the previous month is 100 hours and the total traveling time in the current month is 110 hours, the increase/decrease rate of the traveling times of the plurality of vehicles 1 in the predetermined area A from the previous month to the current month is 10%. On the other hand, if the total traveling time of the plurality of vehicles 1 associated with the predetermined area A in the previous month is 100 hours and the total traveling time in the current month is 80 hours, the increase/decrease rate of the traveling times of the plurality of vehicles 1 in the predetermined area A from the previous month to the current month is −20%.

In the present embodiment, the increase/decrease rate based on the total traveling time of the plurality of vehicles 1 is acquired. However, the increase/decrease rate may be acquired based on the average time (total traveling time/number of vehicles) of the traveling times of the plurality of vehicles.

If the order quantity calculation apparatus 3 calculates the order quantity in the month after next, the traveling time information acquisition unit 315b also acquires increase/decrease rates (%) of the traveling times in the current month, the next month, and the month after next, as the target months. The increase/decrease rates (%) of the traveling times in the current month are acquired as described above. The increase/decrease rate (%) of the traveling time in the next month is acquired using the traveling time in the current month and the predicted traveling time of the next month. As the estimated traveling time in the next month, for example, an approximate line is created from the past record of traveling time, and the predicted traveling time in the next month obtained from the created approximate line can be used. Similarly, the increase/decrease rate (%) of the traveling time in the month after next is acquired using the predicted traveling time in the next month and the predicted traveling time in the month after next obtained from the approximate line created from the past record of traveling time.

The sudden braking information acquisition unit 315c acquires information on a difference in the number of times the plurality of vehicles 1 suddenly applied the brake between the target month (first predetermined period) and the previous month of the target month (second predetermined period). For example, if the current month is the target month, the sudden braking information acquisition unit 315c compares the number of times the plurality of vehicles 1 suddenly applied the brake in the previous month with the number of times the plurality of vehicles 1 suddenly applied the brake in the current month, and acquires an increase/decrease rate (%) of the number of times the plurality of vehicles 1 suddenly applied the brake from the previous month to the current month. Specifically, the sudden braking information acquisition unit 315c detects the number of occurrences of sudden braking from the brake information transmitted from each of the plurality of vehicles 1, and acquires an increase/decrease rate (%) of the number of occurrences of sudden braking.

For example, if the number of times the plurality of vehicles 1 associated with the predetermined area A applied sudden braking in the previous month is 10 and the number of times the plurality of vehicles 1 applied sudden braking in the current month is 11, the rate of increase/decrease in the number of times the plurality of vehicles 1 applied sudden braking in the predetermined area A from the previous month to the current month is 10%. On the other hand, if the number of times the plurality of vehicles 1 associated with the predetermined area A applied sudden braking in the previous month is 10 and the number of times the plurality of vehicles 1 applied sudden braking in the current month is 8, the rate of increase/decrease in the number of times the plurality of vehicles 1 applied sudden braking in the predetermined area A from the previous month to the current month is −20%.

In the present embodiment, the increase/decrease rate based on the total number of times the plurality of vehicles 1 applied sudden braking is acquired, but the increase/decrease rate may be acquired based on the average number of times the plurality of vehicles applied sudden braking (total number of times/number of vehicles).

If the order quantity calculation apparatus 3 calculates the order quantity in the month after next, the sudden braking information acquisition unit 315c also acquires increase/decrease rates (%) of the numbers of occurrences of sudden braking in the current month, the next month, and the month after next, as the target months. The increase/decrease rate (%) of the number of occurrences of sudden braking in the current month is acquired as described above. The increase/decrease rate (%) of the number of occurrences of sudden braking in the next month is acquired using the number of occurrences of sudden braking in the current month and the predicted number of occurrences of sudden braking in the next month. As the predicted number of occurrences of sudden braking in the next month, for example, an approximate line is created from the past record of the number of occurrences of sudden braking, and the predicted number of occurrences of sudden braking in the next month obtained from the created approximate line can be used. Similarly, the increase/decrease rate (%) of the number of occurrences of sudden braking in the month after next is acquired using the predicted number of occurrences of sudden braking in the next month and the predicted number of occurrences of sudden braking in the month after next obtained from the approximate line created from the past record of the number of occurrences of sudden braking.

The order quantity calculation unit 316 calculates the future order quantity of the repair parts in the predetermined area Abased on the average demand quantity calculated by the average demand quantity calculation unit 314 and the vehicle information acquired by the vehicle information acquisition unit 315. For example, the order quantity calculation unit 316 calculates the future order quantity of the repair parts in the predetermined area A based on the average demand quantity calculated by the average demand quantity calculation unit 314, the increase/decrease rate (%) of the number of used vehicles 1 acquired by the use frequency information acquisition unit 315a, the increase/decrease rate (%) of the traveling time acquired by the traveling time information acquisition unit 315b, and the increase/decrease rate (%) of the number of occurrences of sudden braking acquired by the sudden braking information acquisition unit 315c.

Specifically, the order quantity calculation unit 316 calculates an expected current-month demand F0 with the current month as the target month, an expected next-month demand F1 with the next month as the target month, and an expected month-after-next demand F2 with the month after next as the target month, and calculates a monthly average demand quantity AMC of the expected current-month demand F0, the expected next-month demand F1, and the expected month-after-next demand F2 as the order quantity.

The expected current-month demand F0 is calculated by adding an average demand quantity, a quantity obtained by multiplying the average demand quantity by an increase or decrease in the number of used vehicles in the current month, a quantity obtained by multiplying the average demand quantity by an increase or decrease in the traveling time in the current month, and a quantity obtained by multiplying the average demand quantity by an increase or decrease in the number of occurrences of sudden braking in the current month. The expected next-month demand F1 is calculated by adding an average demand quantity, a quantity obtained by multiplying the average demand quantity by an increase or decrease in the number of used vehicles in the next month, a quantity obtained by multiplying the average demand quantity by an increase or decrease in the traveling time in the next month, and a quantity obtained by multiplying the average demand quantity by an increase or decrease in the number of occurrences of sudden braking in the next month. The expected month-after-next demand F2 is calculated by adding an average demand quantity, a quantity obtained by multiplying the average demand quantity by an increase or decrease in the number of used vehicles in the month-after-next, a quantity obtained by multiplying the average demand quantity by an increase or decrease in the traveling time in the month-after-next, and a quantity obtained by multiplying the average demand quantity by an increase or decrease in the number of occurrences of sudden braking in the month-after-next. The order quantity calculation unit 316 sets the average of the expected current-month demand F0, the expected next-month demand F1, and the expected month-after-next demand F2 calculated as the monthly average demand quantity AMC, and sets the average as the order quantity.

For example, if the average demand quantity is 100, the increase/decrease rate of the number of used vehicles is 20%, the increase/decrease rate of the traveling time is 10%, and the increase/decrease rate of the number of occurrences of sudden braking is −20% in the current month, the expected current-month demand F0 is F0=100+20+10−20=110. For example, if the average demand quantity is 120, the increase/decrease rate of the number of used vehicles is 10%, the increase/decrease rate of the traveling time is 15%, and the increase/decrease rate of the number of occurrences of sudden braking is −30% in the next month, the expected next-month demand F1 is F1=120+10+15−30=115. For example, when the average demand quantity is 130, the increase/decrease rate of the number of used vehicles is 5%, the increase/decrease rate of the traveling time is 10%, and the increase/decrease rate of the number of occurrences of sudden braking is −10% in the month after next, the expected month-after-next demand F2 is F2=130+5+10−10=135. From these values, the monthly average demand quantity AMC is AMC=(110+115+135)/3≈127 (pieces), and the order quantity in the month after next is 127 (pieces).

According to the present embodiment, the following operations and advantageous effects can be achieved.

(1) The order quantity calculation apparatus 3 according to the present embodiment is an apparatus that predicts a demand for replacement or repair of repair parts used for each of the plurality of vehicles 1 linked with the predetermined area A and calculates the order quantity of the repair parts. The order quantity calculation apparatus 3 includes the average demand quantity calculation unit 314 that calculates an average demand quantity of repair parts for one month based on results of past order quantities of the repair parts, the vehicle information acquisition unit 315 that acquires vehicle information of each of the plurality of vehicles 1 for one month, and the order quantity calculation unit 316 that calculates a future order quantity of the repair parts in the predetermined area A based on the average demand quantity calculated by the average demand quantity calculation unit 314 and the vehicle information acquired by the vehicle information acquisition unit 315.

With this configuration, since the demand for repair parts is predicted by acquiring the vehicle information of the individual vehicles 1 actually on the market, it is possible to accurately predict the demand for the repair parts, and it is possible to prevent surplus stock or stock shortage. That is, it is possible to maintain proper stock of the repair parts.

(2) The vehicle information acquisition unit 315 includes the use frequency information acquisition unit 315a that acquires information on a difference in the use frequency of the plurality of vehicles 1 between the target month (first predetermined period) and the previous month of the target month (second predetermined period). The order quantity calculation unit 316 calculates the future order quantity of the repair parts in the predetermined area based on the information on the difference in the use frequency acquired by the use frequency information acquisition unit 315a and the average demand quantity. With this configuration, the demand for parts is predicted based on the information on the actual use frequency of the vehicles 1 (for example, increase or decrease in use frequency), so that the demand for parts can be predicted more accurately.

(3) The vehicle information acquisition unit 315 further includes the traveling time information acquisition unit 315b that acquires information on a difference in the traveling time of the plurality of vehicles 1 between the target month (first predetermined period) and the previous month of the target month (second predetermined period), and the sudden braking information acquisition unit 315c that acquires information on a difference in the number of occurrences of sudden braking of the plurality of vehicles 1 between the target month (first predetermined period) and the previous month of the target month (second predetermined period). The order quantity calculation unit 316 calculates the future order quantity of the repair parts in the predetermined area based on the information on the difference in traveling time acquired by the traveling time information acquisition unit 315b, the information on the difference in the number of occurrences of sudden braking acquired by the sudden braking information acquisition unit 315c, the information on the difference in use frequency, and the average demand quantity.

As the traveling time is longer, each vehicle 1 has an increased risk of an accident or the like, and as the number of occurrences of sudden braking increases, the consumption amount of parts increases and the risk of an accident also increases. With this configuration, the demand for parts is predicted based on the information on the actual traveling times of the vehicles 1 (for example, an increase in traveling time) and the information on the number of occurrences of sudden braking (increase in the number of occurrences of sudden braking), so that the demand for parts can be predicted more accurately.

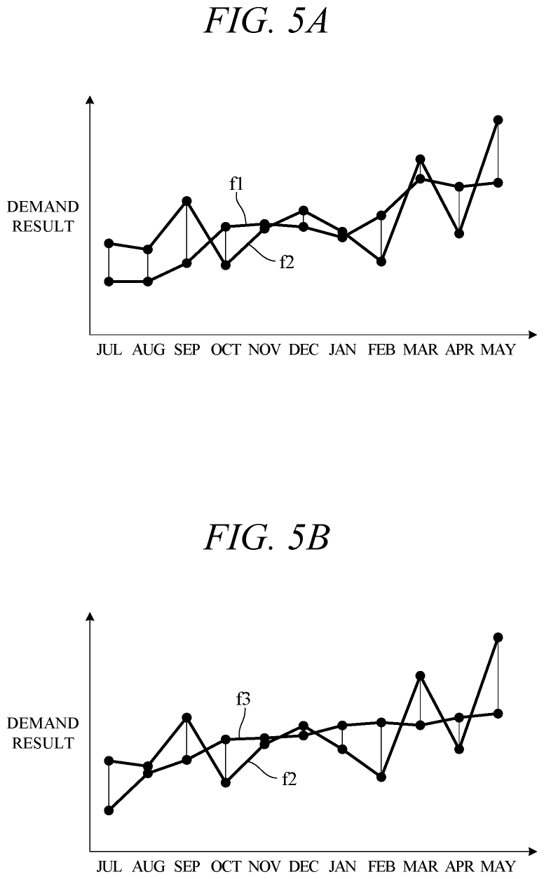

FIG. 5A is a diagram illustrating demand predictions of repair parts calculated by the order quantity calculation apparatus 3 according to the present embodiment and actual demand results, and FIG. 5B is a diagram illustrating demand predictions of repair parts calculated by a conventional order quantity calculation apparatus and actual demand results. Referring to FIGS. 5A and 5B, a characteristic f1 indicates the demand predictions of the repair parts calculated by the order quantity calculation apparatus 3, a characteristic f2 indicates the demand results of the repair parts, and a characteristic f3 indicates the demand predictions of the repair parts calculated by a conventional calculation apparatus. As illustrated in FIG. 5B, the conventional demand predictions produce an average waveform with respect to the demand results, whereas as illustrated in FIG. 5A, the demand predictions of the repair parts according to the present embodiment produce a waveform along the demand results, which can be said to be predictions closer to the demand results.

(4) The plurality of vehicles 1 has the same repair parts. With this configuration, it is possible to accurately predict the demand even for parts that are difficult to predict and have a long carry-in lead time, such as repair parts.

(5) The order quantity calculation system according to the present embodiment includes the order quantity calculation apparatus 3 and the in-vehicle apparatus 2 that is mounted in each of the plurality of vehicles 1 and is communicable with the order quantity calculation apparatus 3. With this configuration, since the demand for parts is predicted by acquiring the vehicle information of the individual vehicles 1 actually on the market, it is possible to accurately predict the demand for the parts, and it is possible to prevent surplus stock or stock shortage. That is, it is possible to maintain proper stock the parts.

In the above embodiment, the vehicle information acquisition unit 315 includes the use frequency information acquisition unit 315a, the traveling time information acquisition unit 315b, and the sudden braking information acquisition unit 315c, but the present invention is not limited thereto. The vehicle information acquisition unit 315 may include only the use frequency information acquisition unit 315a, or may acquire vehicle information other than the information from the use frequency information acquisition unit 315a, the traveling time information acquisition unit 315b, and the sudden braking information acquisition unit 315c.

In the above embodiment, the average demand quantity calculation unit 314 multiplies the average value of the order quantity per month calculated from the results of the order quantities in the last past six months by the trend coefficient and the season coefficient to calculate the average demand quantity of repair parts. However, the present invention is not limited thereto. For example, the average demand quantity calculation unit 314 may calculate the average demand quantity of the repair parts by multiplying the above-described average value by a preset coefficient of variation. The coefficient of variation can be set higher as the number of vehicles corresponding to the repair parts on the market is larger, and can be set lower as the number of vehicles is smaller, for example.

In the above embodiment, the example of calculating the order quantity of the repair parts in the month after next month in the predetermined area has been described. However, the present invention is not limited thereto. For example, the order quantity in the next month may be calculated, or the order quantities in the month after next and subsequent months may be calculated.

In the above embodiment, the example of calculating the order quantity of the repair parts as the predetermined parts has been described, but the present invention can also be applied to parts other than the repair parts.

The above description is only an example, and the present invention is not limited to the above embodiment and modifications, unless impairing features of the present invention. The above embodiment can be combined as desired with one or more of the above modifications. The modifications can also be combined with one another.

### REFERENCE SIGNS LIST

1 vehicle, 2 in-vehicle apparatus, 3 order quantity calculation apparatus, 100 order quantity calculation system, 314 average demand quantity calculation unit, 315 vehicle information acquisition unit, 316 order quantity calculation unit, A predetermined area.

1. An order quantity calculation apparatus configured to predict a demand for replacement or repair of predetermined parts used for each of a plurality of vehicles linked with a predetermined area and to calculate an order quantity of the predetermined parts, comprising:
a processor and a memory coupled to the processor, wherein
the processor is configured to perform:
calculating an average demand quantity of the predetermined parts for a predetermined period based on a result of a past order quantity of the predetermined parts;
acquiring vehicle information of each of the plurality of vehicles for the predetermined period; and
calculating a future order quantity of the predetermined parts in the predetermined area based on the average demand quantity and the vehicle information.

2. The order quantity calculation apparatus according to claim 1, wherein
the processor is further configured to perform:
acquiring information on a difference in a use frequency of the plurality of vehicles between a first predetermined period and a second predetermined period, wherein
the calculating the future order quantity includes calculating the future order quantity of the predetermined parts in the predetermined area based on the information on the difference in the use frequency and the average demand quantity.

3. The order quantity calculation apparatus according to claim 2, wherein
the acquiring the vehicle information includes:
acquiring information on a difference in a traveling time of the plurality of vehicles between the first predetermined period and the second predetermined period; and
acquiring information on a difference in a number of occurrences of sudden braking of the plurality of vehicles between the first predetermined period and the second predetermined period, wherein
the calculating the future order quantity includes calculating the future order quantity of the predetermined parts in the predetermined area based on the information on the difference in the traveling time, the information on the difference in the number of occurrences of sudden braking, the information on the difference in the use frequency, and the average demand quantity.

4. The order quantity calculation apparatus according to claim 1, wherein
each of the plurality of vehicles has the predetermined parts identical to each other.

5. An order quantity calculation system, comprising: an order quantity calculation apparatus according to claim 1, and an in-vehicle apparatus mounted in each of the plurality of vehicles and communicable with the order quantity calculation apparatus.
